(19) United States
(12) Patent Application Publication
(10) Pub. No.: US 2018/0285786 A1
(43) Pub. Date: Oct. 4, 2018

(54) SYSTEM AND METHOD FOR PROVIDING SELECTIVE ACCESS TO RESTRICTED RESOURCES

(71) Applicant: DISTINGUISHED CLUBS OF THE WORLD LLC, Laguna Beach, CA (US)

(72) Inventor: Keith Jarrett, Newport Beach, CA (US)

(21) Appl. No.: 15/942,387

(22) Filed: Mar. 30, 2018

Related U.S. Application Data
(60) Provisional application No. 62/480,277, filed on Mar. 31, 2017.

(51) Int. Cl. G06Q 10/02

(52) U.S. Cl. CPC G06Q 10/025

(57) ABSTRACT

In some implementations, there is provided a system and method for providing selective access to restricted resources.

### RELATED APPLICATIONS

This application claims priority to U.S. Provisional Application Ser. No. 62/480,277 filed Mar. 31, 2017, entitled “SYSTEM AND METHOD FOR PROVIDING SELECTIVE ACCESS TO RESTRICTED RESOURCES, which is incorporated herein by reference in its entirety.

### TECHNICAL FIELD

The present invention generally relates to resource allocation, and more specifically, to systems and methods related to providing selective access to restricted resources.

### SUMMARY

For any company in any service-oriented industry (e.g., retail, hotels, country clubs), simply as a matter of physical size of the facilities, there are limits on the number of resources (also referred to herein as “amenities” or “services”) that can be provided to its customers (also referred to herein as “members”). Thus, there is an interest in forming networks of companies to combine amenity offerings to the collective membership. Such a network can greatly enhance the sheer volume of resources offered to members, as well as provide additional unique resources available at one company's facilities that are not available at another company's facilities.

However, when providing such access to a larger network of companies, there is a need for a system that can allow members to easily request access to such resources while also providing each company with a system to easily evaluate requests and determine whether to provide access to the restricted resource.

Some implementations, described herein, address this problem by implementing management utility software that provides an interface to members and administrators to easily request and provide access to resources.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the disclosed implementations as well as additional aspects and implementations thereof, reference should be made to the Description of Implementations below, in conjunction with the following drawings in which like reference numerals refer to corresponding parts throughout the figures.

In the drawings:

FIG. 1 is a block diagram illustrating an example client-server environment, in accordance with some implementations.

FIG. 2 is a block diagram illustrating a server system, in accordance with some implementations.

FIG. 3 depicts a block diagram illustrating a client device, in accordance with some implementations.

FIGS. 4A-4U illustrate an example user interfaces for providing selective access to restricted resources in accordance with some implementations.

FIG. 5 is a flow diagram illustrating a method for providing selective access to restricted resources in accordance with some implementations.

FIG. 6 is a top-level flow chart of an example system that provides selective access to restricted resources, according to some implementations.

FIGS. 7A, 7B, and 7C illustrate steps performed in a system (e.g., server system 120) that provides selective access to restricted resources, according to some implementations.

### DETAILED DESCRIPTION

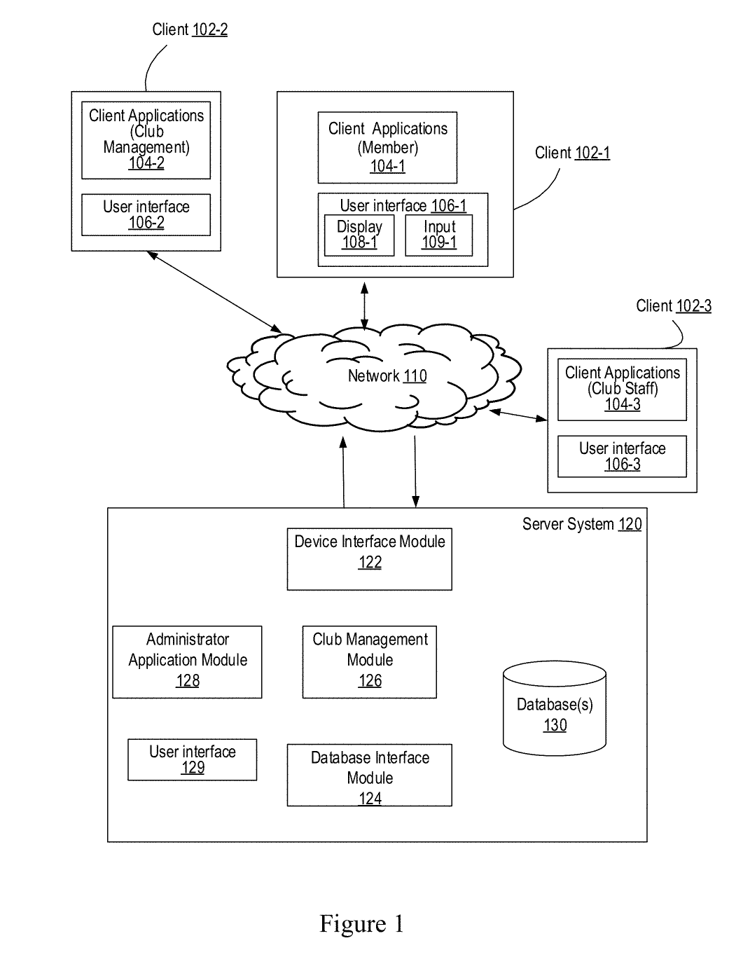

FIG. 1 is a block diagram illustrating an example client-server environment 100 for delivering targeted messages to an individual according to some implementations. In FIG. 1, the client-server environment 100 includes a server system 120, one or more client systems or devices (referred to hereinafter as client) 102. One or more communication networks 110 interconnect these components. The communications network 110 may be any of a variety of networks, including local area networks (LAN), wide area networks (WAN), wireless networks, wired networks, the Internet, or a combination of such networks. In some implementations, a client 102 may connect directly via a wireless connection (e.g., Bluetooth). In some implementations, a client 102 is located in a remote location with respect to the server system 120. In some other implementations, a client 102 is in close proximity to the server system 120.

According to some implementations, a client 102 includes a client application 104 and a user interface 106. The client application 104, when executed by the client 102, sends data to and/or receives data from the server system 120. In some implementations, the user interface 106 includes a display device 108 capable of displaying data and a user input device for user input. The client 102 may be any computer or other electronic device that is capable of communicating with the server system 120. Examples of client 102 include, without limitation, desktop and notebook computers, mainframe computers, server computers, mobile devices such as mobile phones, smart phones, and personal digital assistants, network terminals, and set-top boxes.

The client application 104 may be member specific (e.g., client applications (member) 104-1), club management specific (e.g., client applications (club management) 104-2), or club staff specific (e.g., client applications (club staff) 104-3). For example, in some implementations, client applications (member) 104-1 may be able to request access to amenities (i.e., resources) offered by one or more clubs. In some implementations, client applications (club management) 104-2 may be able to access all access requests for specific amenities from members. In some implementations, client applications (club staff) 104-3 may be able to access member-specific identification information (e.g., member name, identifying photograph, member purchases).

In some implementations, the client 102 may request and/or receive location-specific data (e.g., amenity availability) from system 120. Besides amenity availability, examples of location specific data may include messages (e.g., welcome messages as a user enters a location) from system 120, targeted offers (e.g., custom deals) specific to the user of client 102 from system 120, and timing data (i.e., time spent by a user in a particular location) to track facilities-usage at a private club or buying behavior of a user at a store.

According to some implementations, the server system 120 includes a device interface module 122, a database interface module 124, a club management module 126, and an administrator application module 128. In some implementations, the server system 120 also includes database(s) 130.

In addition to some of the example implementations listed herein, system 120 may be configured to manage communications between different client devices, such as discussions between a member and a club administrator related to a member accessing a facility.

The device interface module 122 is configured to receive requests and responses from client devices and process the requests and responses accordingly. Examples of processing the requests includes: transmitting the requests or responses to the proper client device, tracking the requests and responses in database 130 (via database interface module 124) to manage access to club services, and providing the client devices with user interfaces that can allow users to easily interact with the server system 120.

The club management module 126 may be configured to process the client-specific data in the database 130 to i) manage access for club services, ii) evaluate the member visit and visits of all members, iii) process client-specific data to access and edit member information or identify members, and iv) promote services to members, or transmit surveys to members, based on the members current location. Examples of client-specific data includes club member identifying information, member requests for club services, club member status information, club identifying information and club services information (e.g., description and availability information).

The administrator application module 128 is configured to receive, process and/or display any club data (e.g., club services data), and any member data, described herein, for any facility or club, provided by an administrator, via user interface 129. In some implementations, administrator application module 128 is implemented on client 102 as client application 104-2.

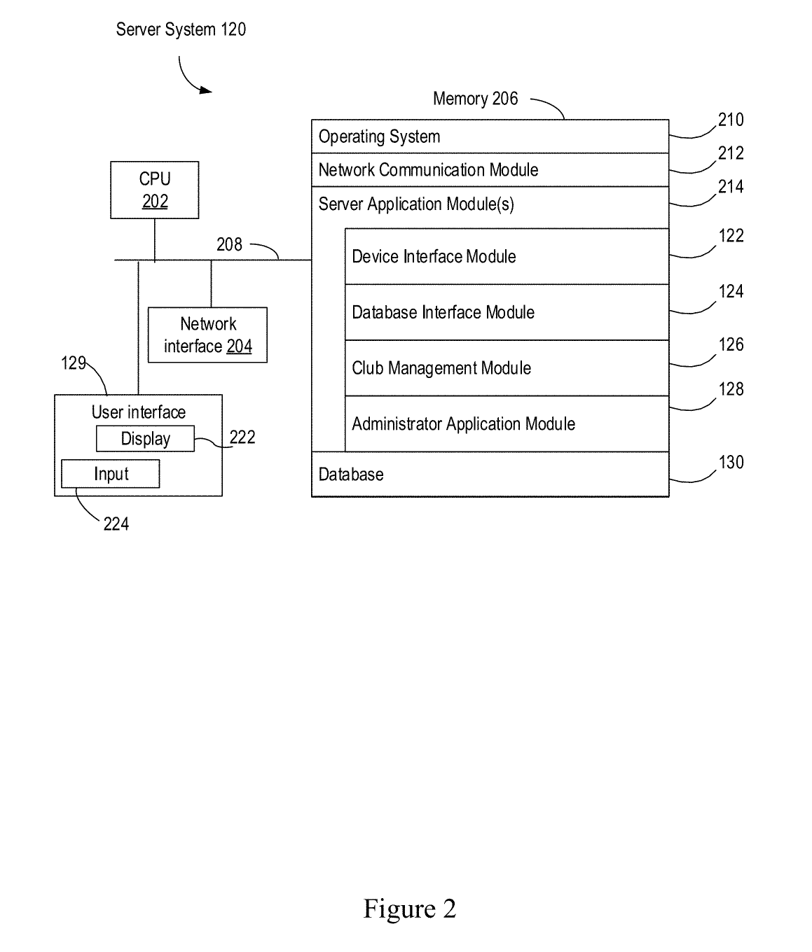

In addition, any or all of the functionality described herein as being associated with a particular module can be implemented in whole or in part, or can be supplemented by additional functionality, in different implementations. FIG. 2 is a block diagram illustrating a server system 120 in accordance with some implementations. The server system 120 typically includes one or more processing units (CPU's) 202, one or more network interfaces 204, a memory 206, and one or more communication buses 208 for interconnecting these components and for connecting with other systems. The server system 120 includes a user interface 129. The user interface 129 includes a display device 222 and a user input 224. The user interface 129 optionally includes an input means such as a keyboard, mouse, a touch sensitive display, or other input buttons (not shown). Furthermore, some clients use a microphone and voice recognition to supplement or replace the keyboard. A memory 206 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. A memory 206 optionally includes one or more storage devices remotely located from the CPU(s) 202. A memory 206, or alternately the non-volatile memory device(s) within memory 206, includes a non-transitory computer readable storage medium.

In some implementations, memory 206 or the computer readable storage medium of memory 206 stores the following programs, modules and data structures, or a subset thereof:
operating system 210 that includes procedures for handling various basic system services and for performing hardware dependent tasks;
a network communication module (or instructions) 212 that is used for connecting the server system 120 to other computers via the one or more communication network interfaces 204 (wired or wireless) and one or more communication networks 110 (FIG. 1), such as the Internet, other wide area networks, local area networks, metropolitan area networks, and so on;
server application modules 214 for performing the services offered by the server system, including but not limited to:
   a device interface module 122 for receiving proximity data, client data, club data (e.g., financial data), data from or transmitting proximity data, client data, club data (e.g., financial data), to one or more clients 102;
   a database interface module 124 for retrieving client-specific data (e.g., client identifying information and membership status) from the database 130 and storing proximity data, client data, club data (e.g., financial data), promotion data and survey data in the database 130;
   a club management module 126 for using the proximity data (e.g., member identifier) and/or the client-specific data (e.g., survey results) in the database 130 to i) manage availability of club services (and tracking requests and responses for club services), ii) evaluate the member visit and visits of all members, and iii) process client-specific data to access and edit member information or identify members;
   an administrator application module 128 for allowing administrators to access, display, edit and create club data (e.g., financial data), member data, promotion data, survey data and club data.
database 130 for i) storing proximity data, client data (e.g., client identifying information and membership status), club data (e.g., financial data), promotion data and survey data from database interface module 124 and ii) providing proximity data, client data, club data (e.g., financial data), promotion data and survey data to database interface module 124.

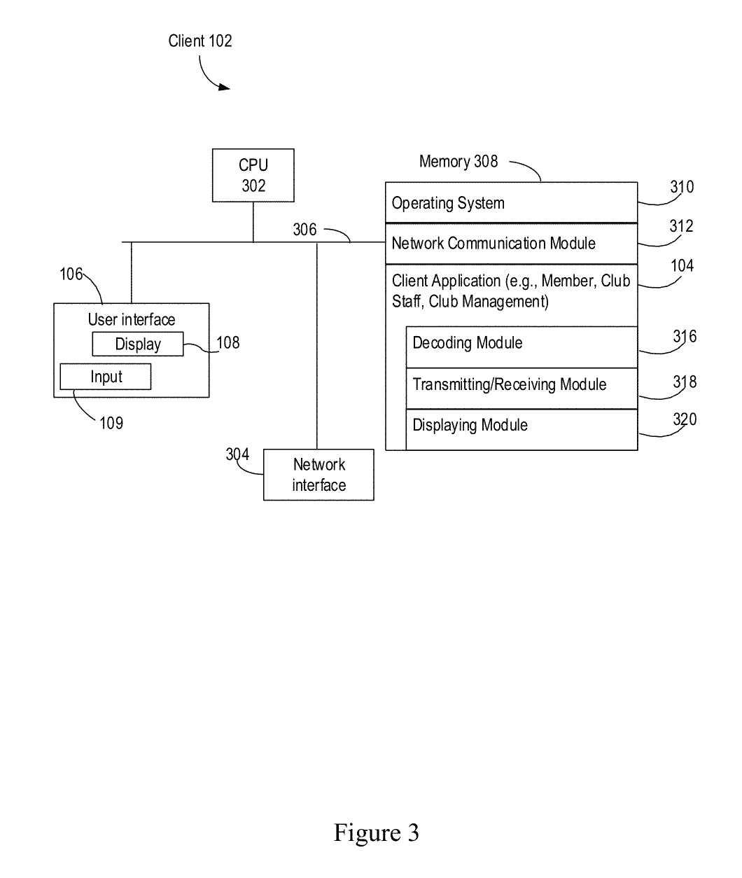

FIG. 3 depicts a block diagram illustrating a client 102 in accordance with some implementations. The client 102 typically includes one or more processing units (CPU's) 302, one or more network interfaces 304, memory 308, and one or more communication buses 306 for interconnecting these components. The client 102 includes a user interface 106. The user interface 106 includes a display device 108 and a user input 109. The user interface 109 optionally includes an input means such as a keyboard, mouse, a touch sensitive display, or other input buttons (not shown). Furthermore, some clients use a microphone and voice recognition to supplement or replace the keyboard.

Memory 308 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. A memory 308 optionally includes one or more storage devices remotely located from the CPU(s) 302. The memory 308, or alternately the non-volatile memory device(s) within the memory 308, includes a non-transitory computer readable storage medium. In some implementations, memory 308 or the computer readable storage medium of memory 308 stores the following programs, modules and data structures, or a subset thereof:
an operating system 310 that includes procedures for handling various basic system services and for performing hardware dependent tasks;
a network communication module 312 that is used for connecting the client 102 to other computers via the one or more communication network interfaces 304 (wired or wireless) and one or more communication networks, such as the Internet, other wide area networks, local area networks, metropolitan area networks, and so on;
one or more client applications 104 (e.g., client applications (member) 104-1, client applications (club management) 104-2 or client applications (club staff) 104-3) including one or more modules for handling various aspects of interacting with server system 120, including but not limited to:
   a decoding module 316 for identifying information from the radio signal;
   a transmitting/receiving module 318 for i) transmitting to server system 120 requests for access to club services at different clubs in the club network and receiving messages from the server indicating availability of club services;
   a displaying module 320 for displaying user interfaces related to access to club services at different clubs in the club network.

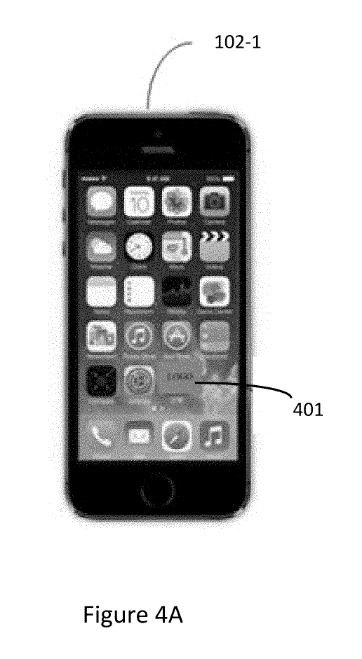

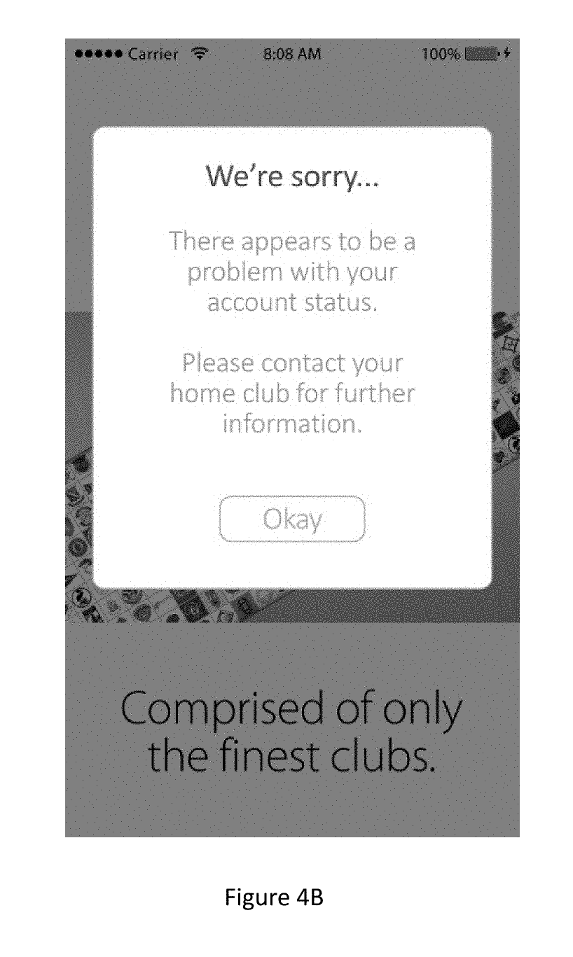

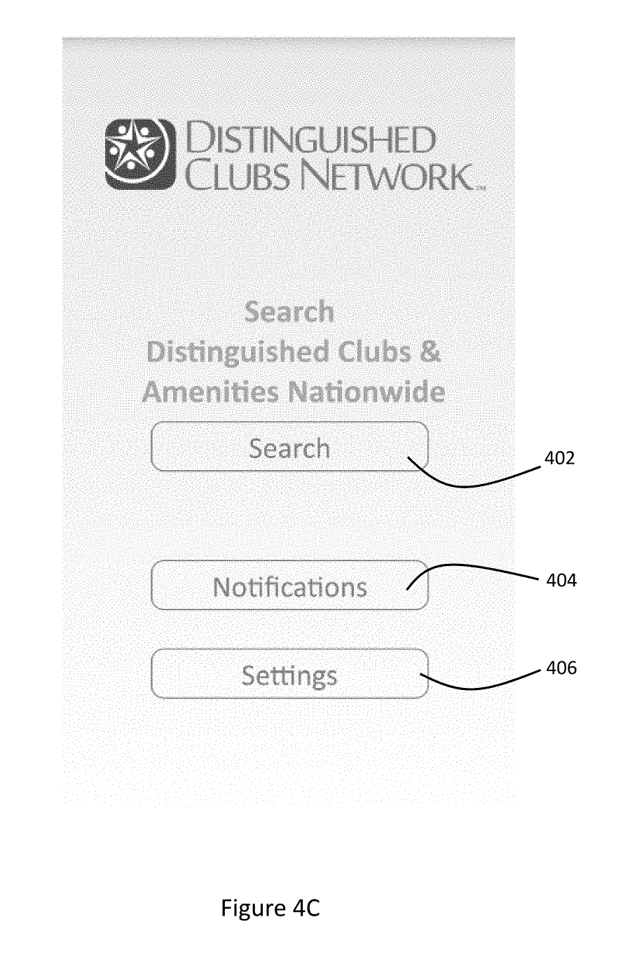

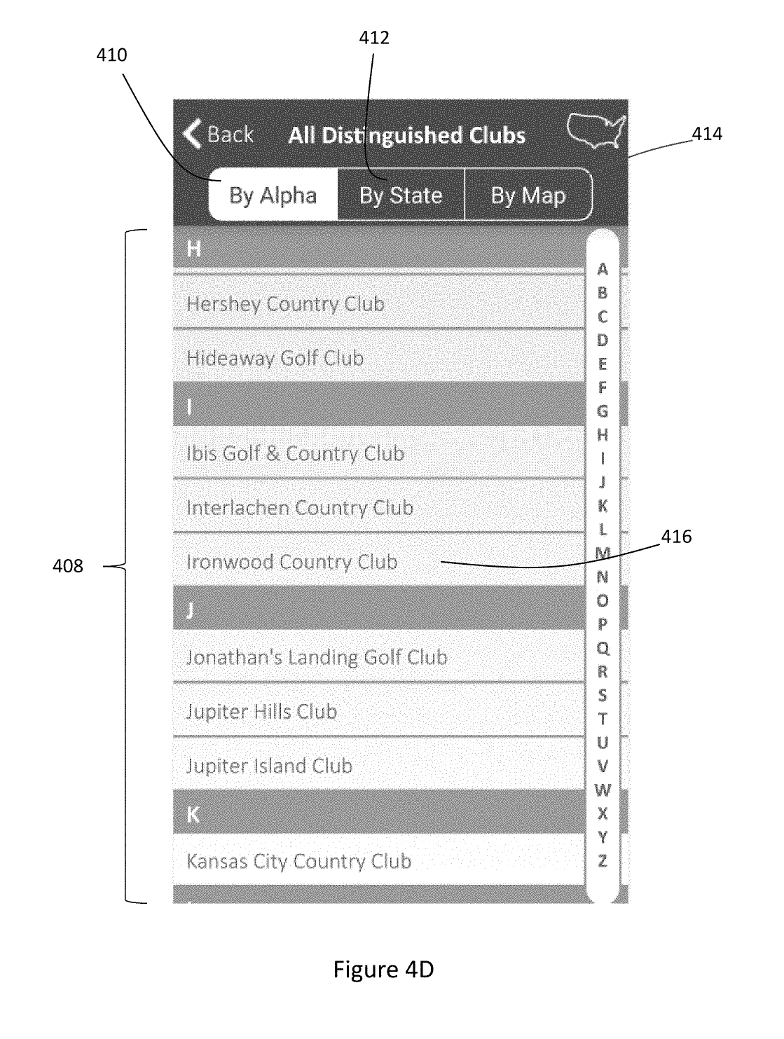

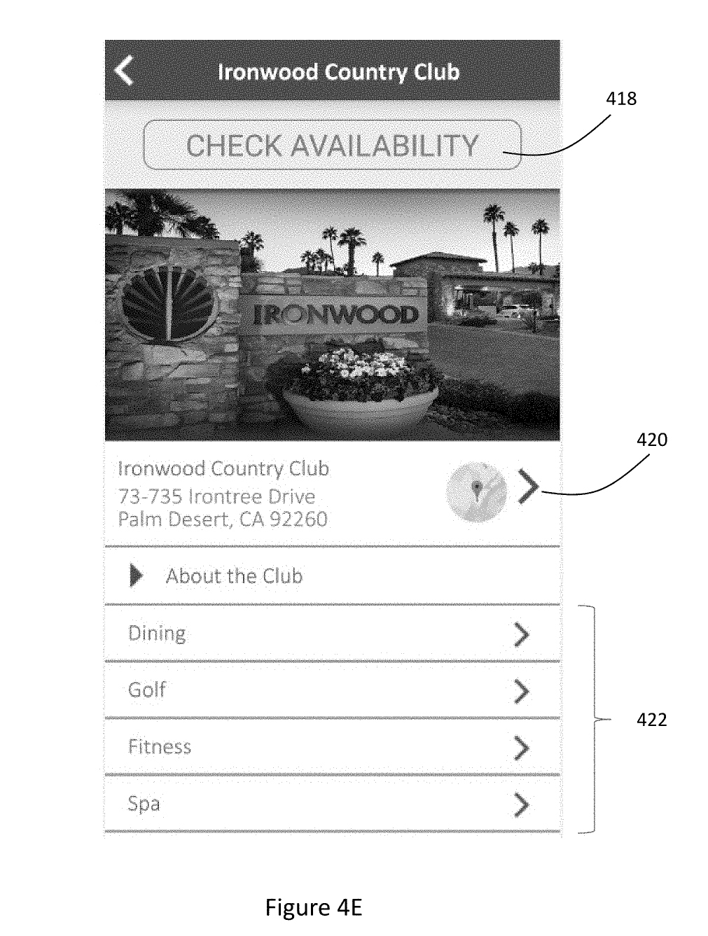

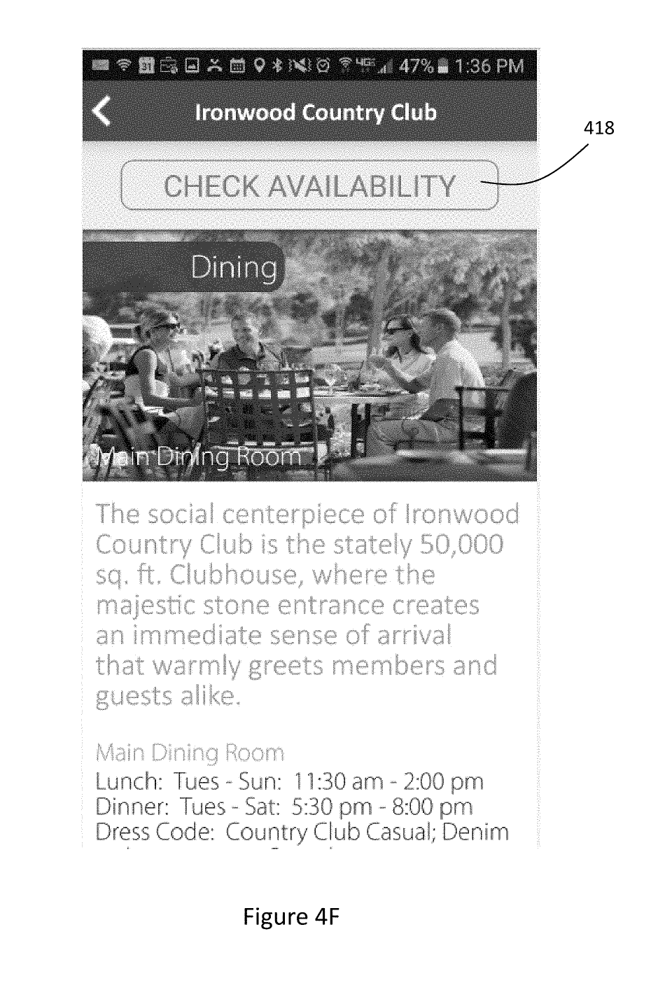

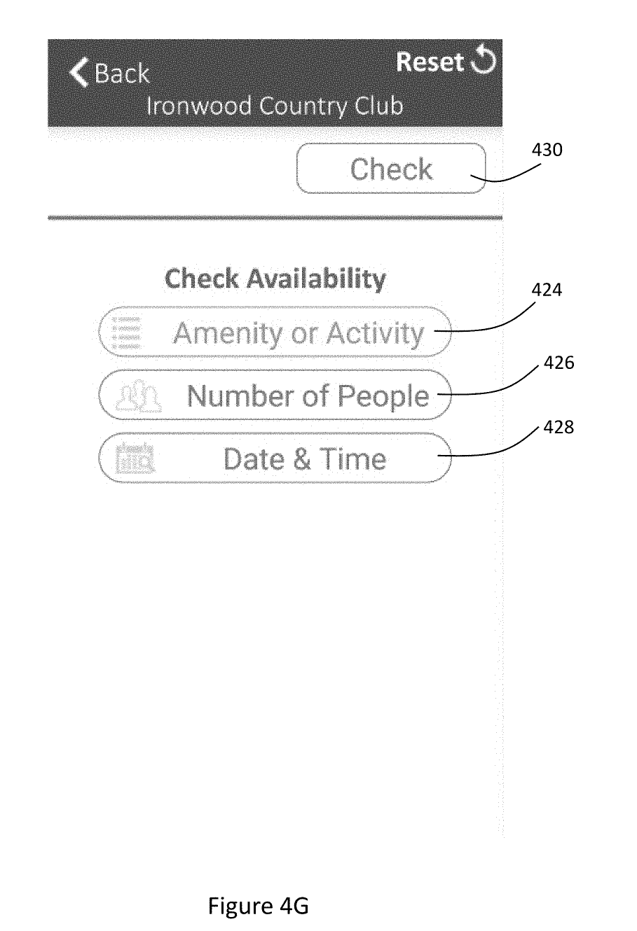

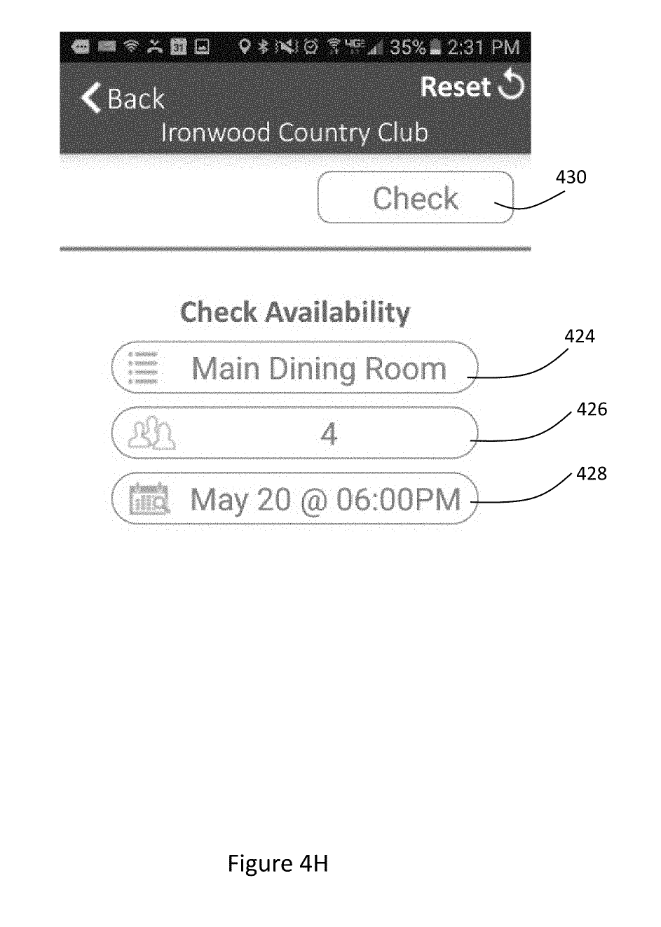

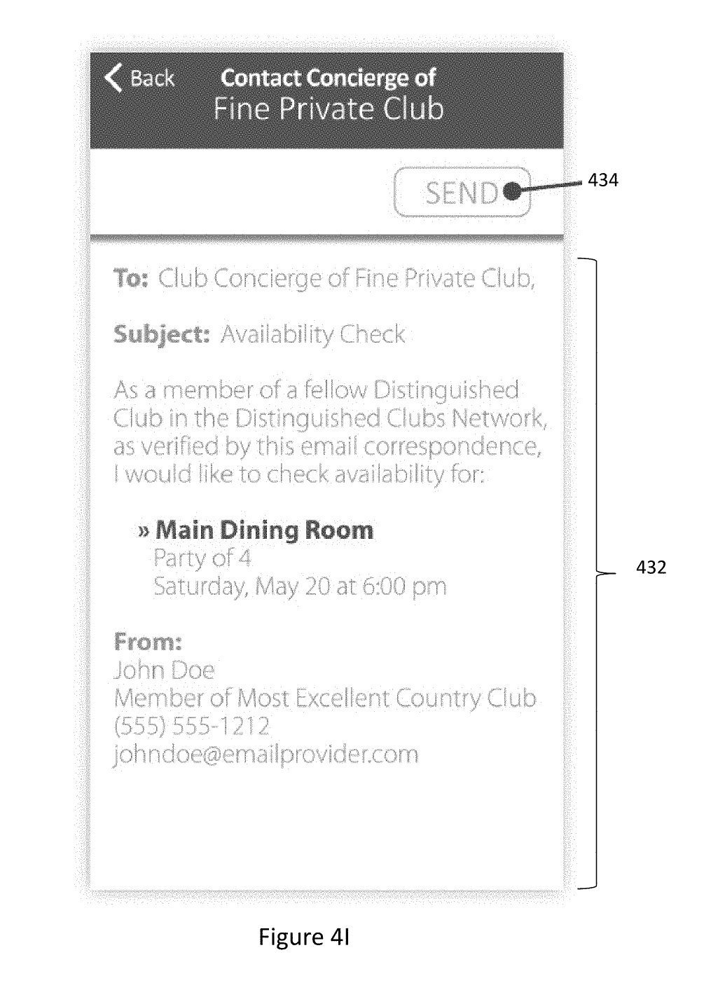

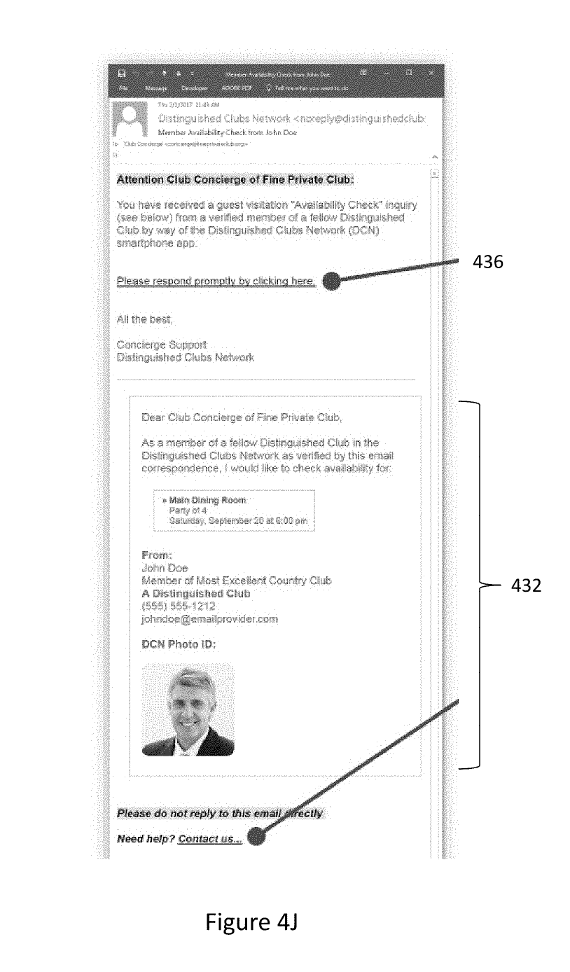

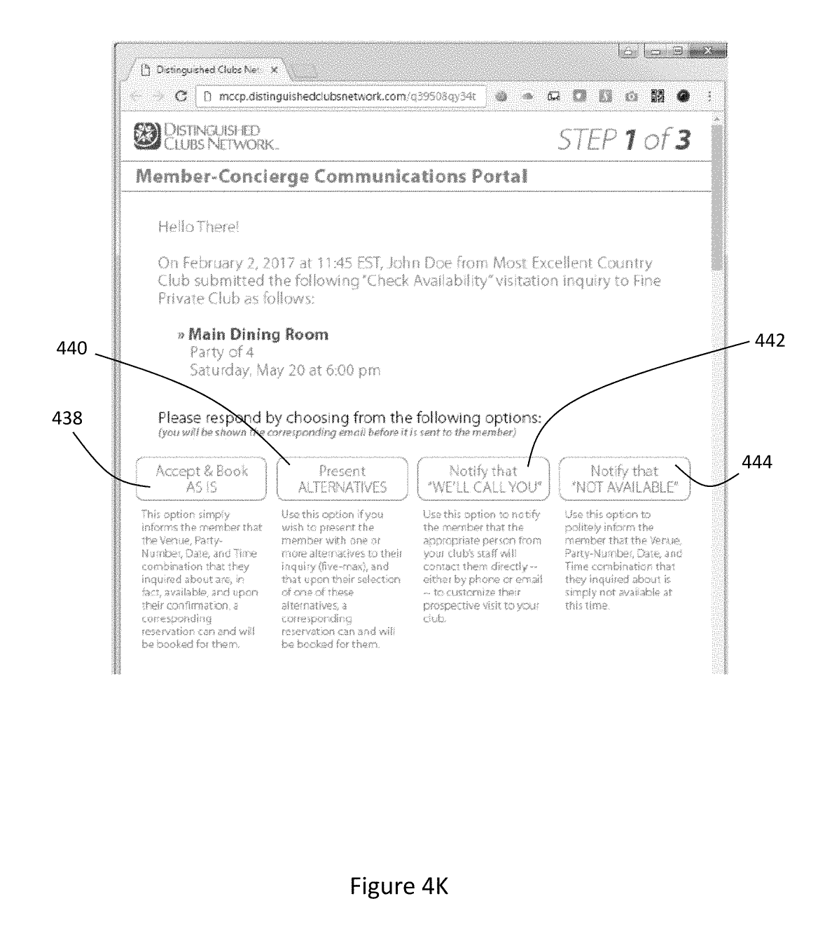

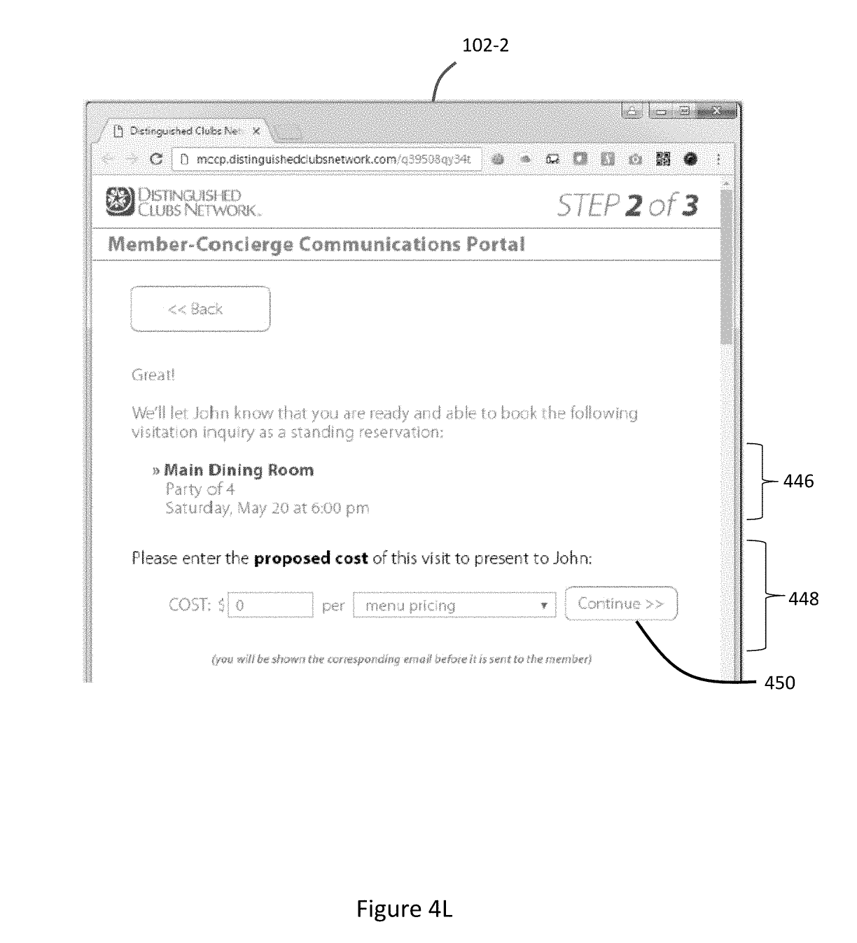

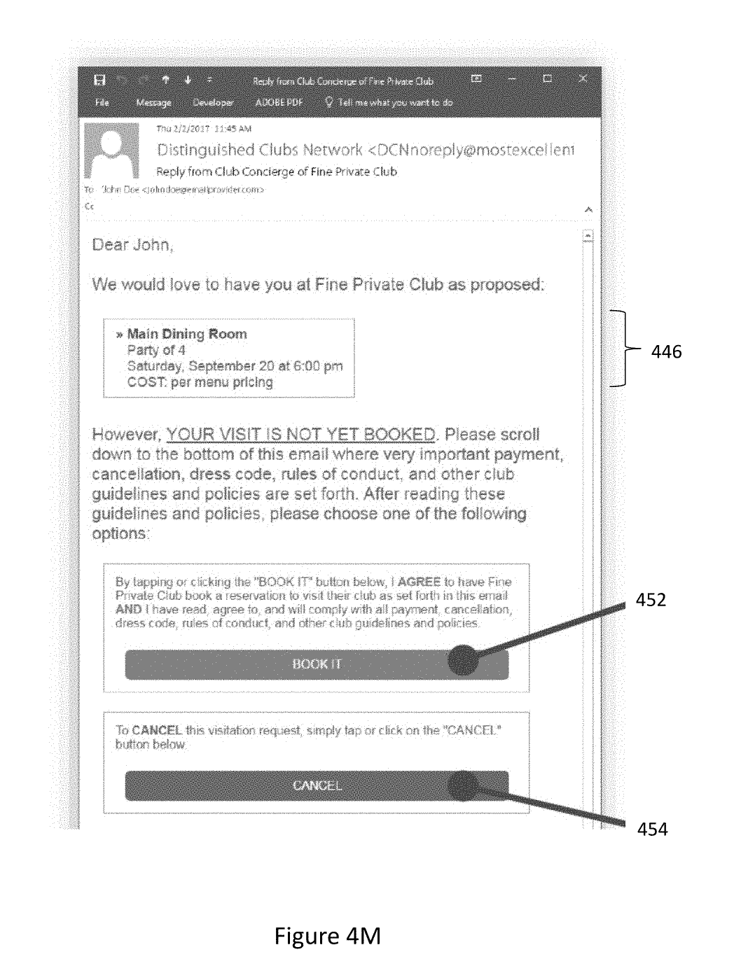

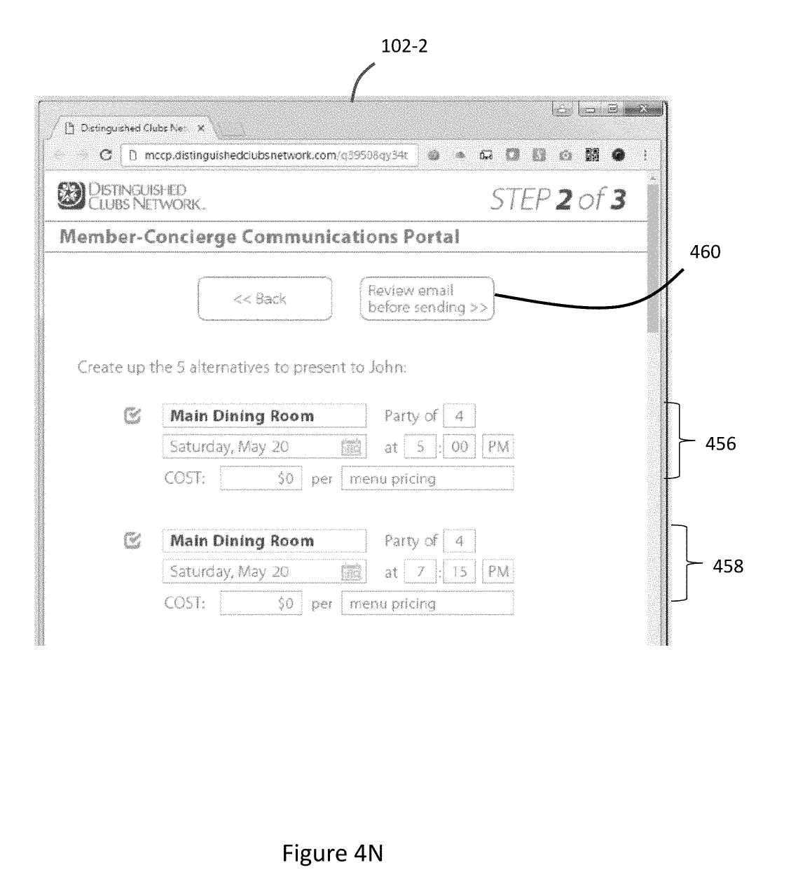

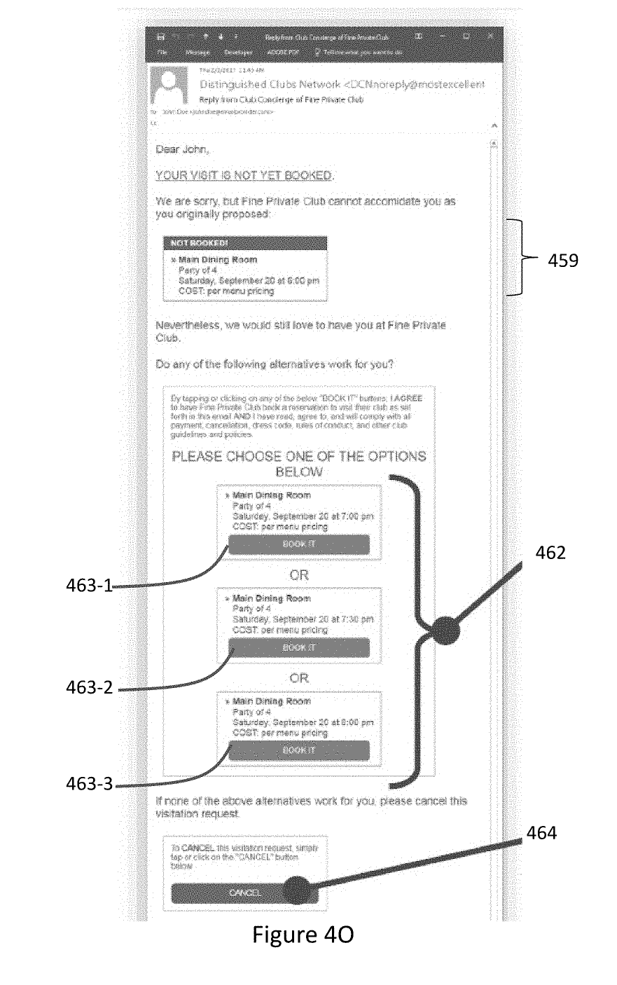

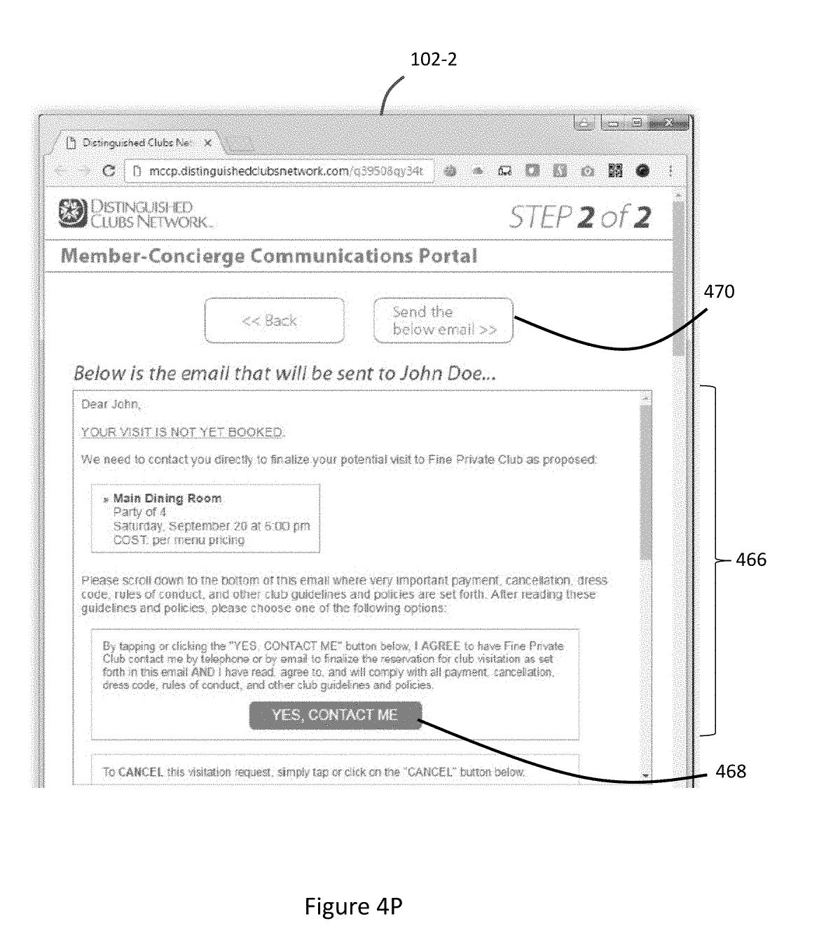

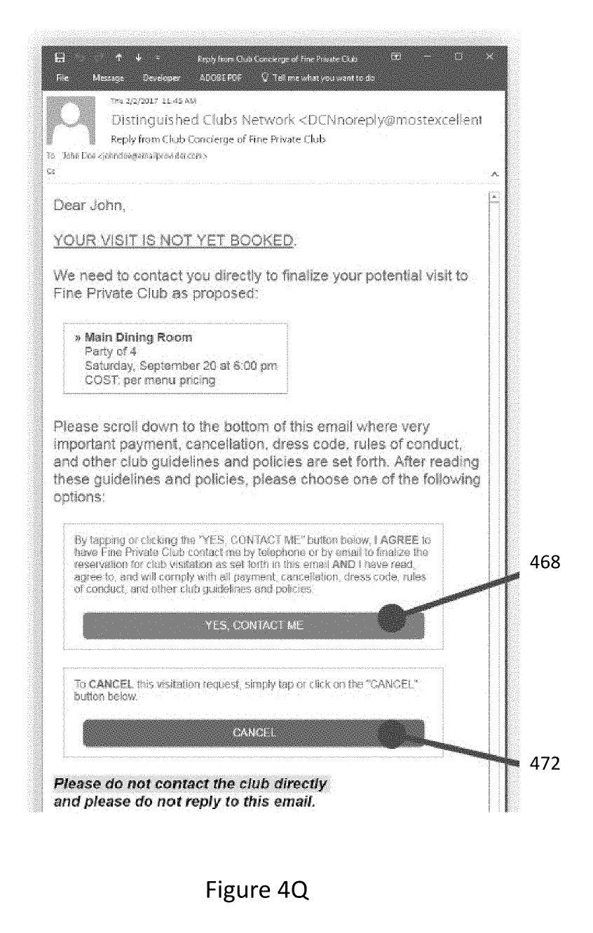

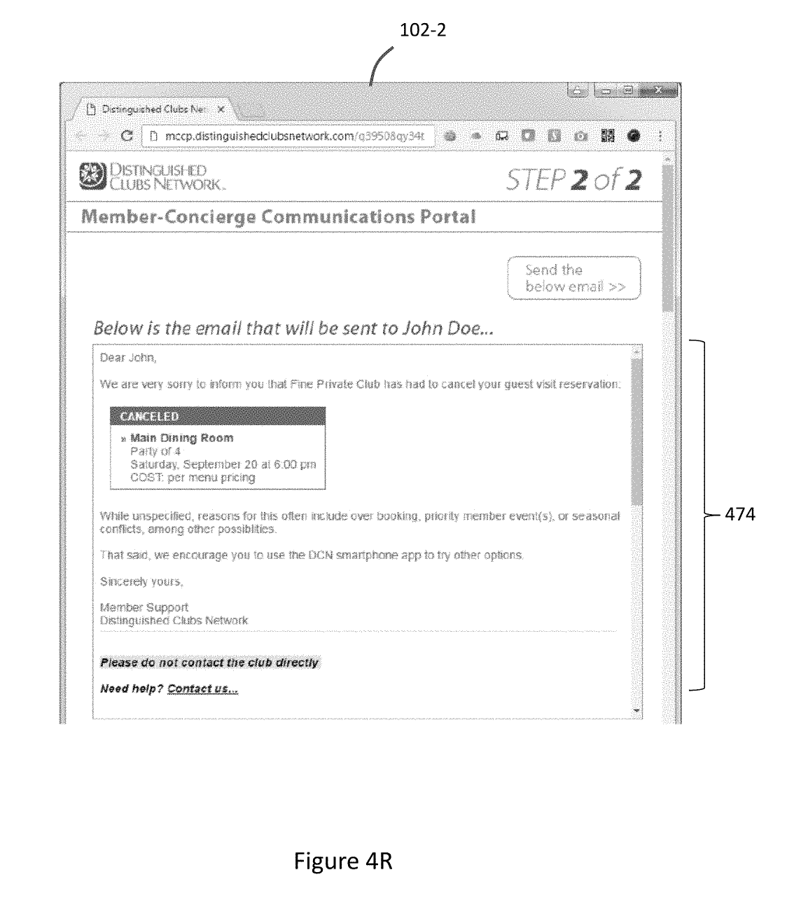

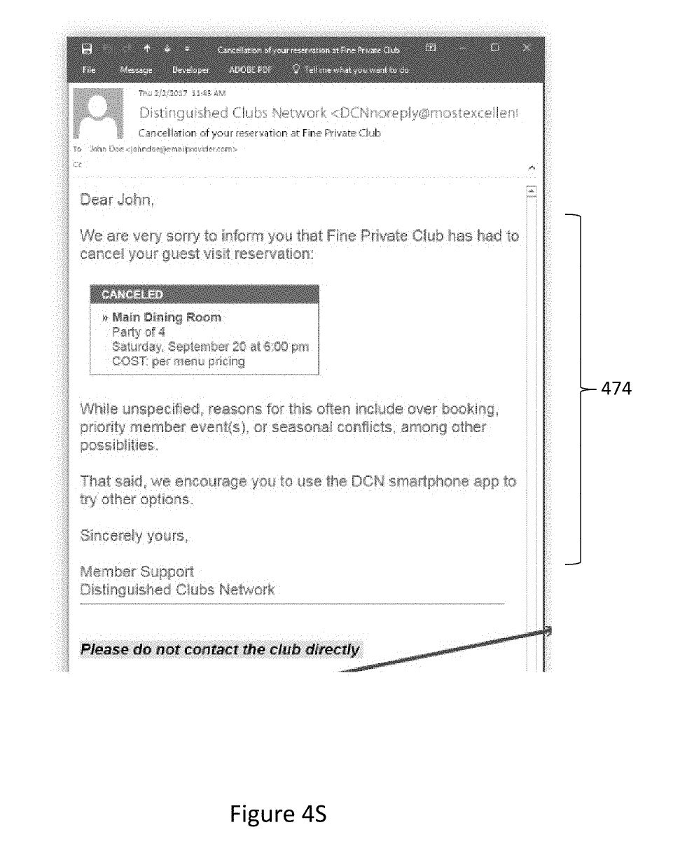

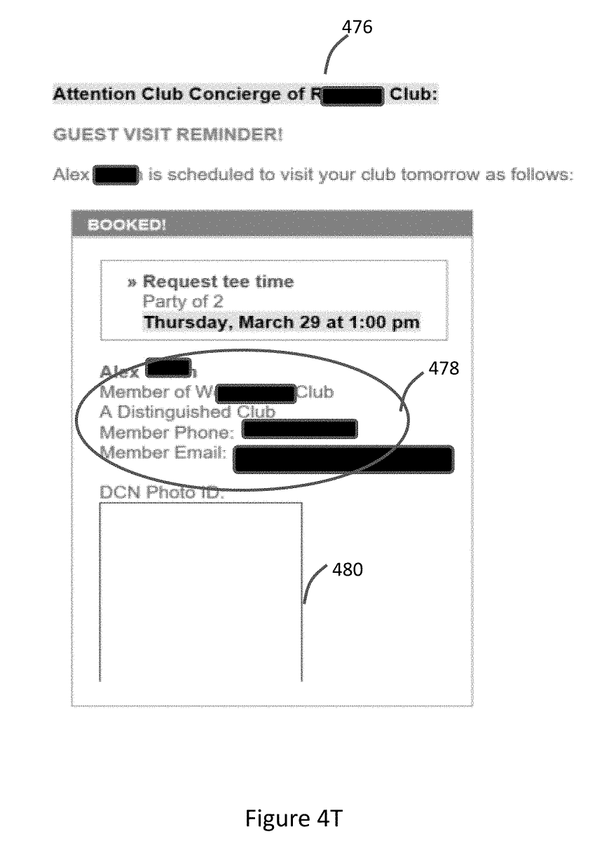

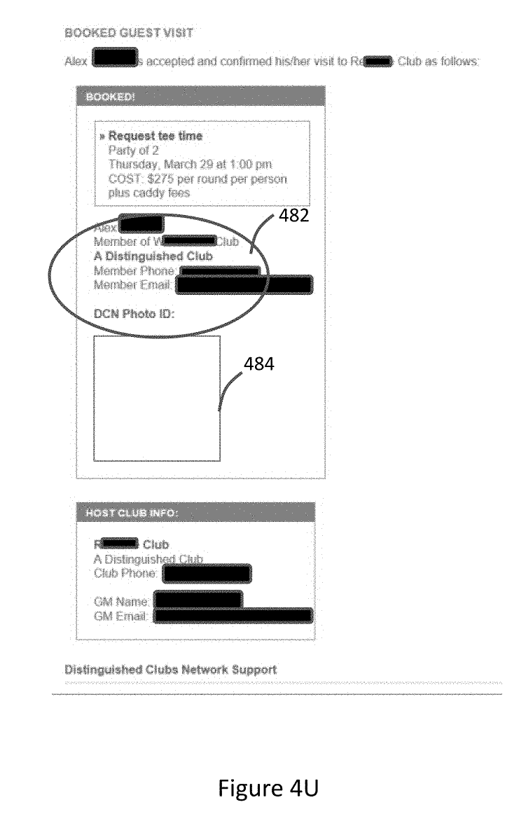

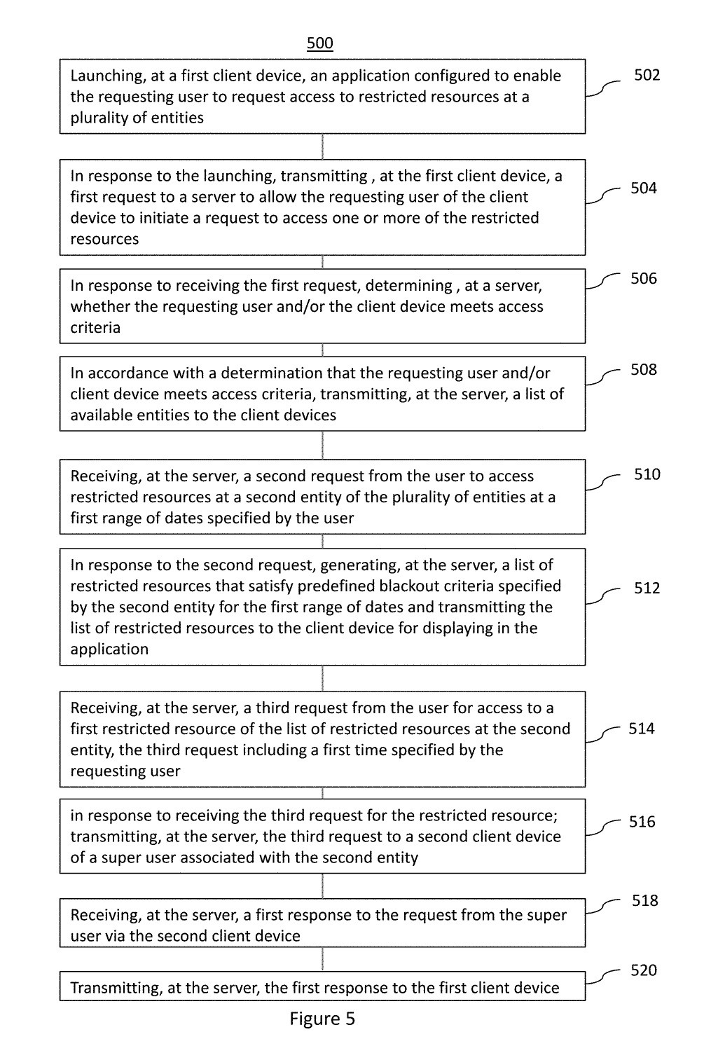

FIGS. 4A-4S illustrate example user interfaces for providing selective access to restricted resources in accordance with some implementations. The user interfaces in these figures are used to illustrate the processes described below, including the process in FIG. 5. For convenience of explanation, some of the implementations will be discussed with reference to operations performed on client devices 102-1 (also referred to herein as member device 102-1) and 102-2 (also referred to herein as administrator device 102-2).

FIG. 4A illustrates an example user interface on the member device 102-1 used by a member of the club network. The member device 102-1 displays an application icon 401. In response to a user selection of the application icon 401, the member device 102-1 transmits a request, to the server system 120, to access information related to the club network. The server system 120 determines whether the member meets access criteria. For example, the server system 120 may check whether a member is suspended by accessing the database 130 to retrieve membership information regarding the member. In accordance with a determination that the member is suspended, the server system 120 denies the member device 102-1 from accessing the club network and transmits the user interface shown in FIG. 4B to the member device 102-1. In accordance with a determination that the member is in good standing or an active membership, the server system 120 allows the member device 102-1 to access the club network and transmits the user interface shown in FIG. 4C to the member device 102-1. Denying a suspended member (or a non-member) access to the membership network as soon as the membership application is opened provides a number of technical and user interaction advantages, including at least: preventing denial of service attacks on the server system 120 from unauthorized users; providing immediate and visible notice to a suspended user of a problem with their membership status, thereby preventing frustration of a user who submits a request for access to a restricted resource that is subsequently denied; promoting efficient use of network and computing resources that would be wasted in processing futile requests for access to restricted resources; and promoting efficient user of club membership staff who would need to review and send messages to reject futile requests for access to restricted resources.

In FIG. 4C, the member device 102-1 displays selectable objects, such as search object 402, notifications object 404 and settings object 406. In response to a user selection of the search object 402, the member device 102-1 transmits a request to the server system 120 to provide a list of available clubs in a searchable format. In response to the request, the server system 120 transmits the user interface shown in FIG. 4D to the member device 102-1. As shown in FIG. 4D, member device 102-1 displays a directory of available clubs 408. The member device 102-1 further displays selectable objects which allow the user to select how the directory of available clubs 408 is displayed on member device 102-1. For example, the directory of available clubs 408 may be presented as a list of club names arranged in alphabetical order in response to a user selection of alpha object 410, as shown in FIG. 4D. The directory of available clubs 408 may also be arranged by state in response to a user selection of a state object 412, or shown geographically on a map display in response to a user selection of a map object 414.

Each entry in the directory of available clubs 408 displayed on member device 102-1 as a selectable object which, when selected by the user, will transmit a request to server system 120 to provide further information pertaining to the club corresponding to the selected entry. For example, in response to a user selection of an Ironwood Country Club object 416 from the directory of available clubs 408, the member device 102-1 transmits a request to the server system 120 to provide information pertaining to the Ironwood Country Club. In response to the request, the server system 120 transmits the user interface shown in FIG. 4E to the member device 102-1 which provides user access to information about the Ironwood Country Club.

In the user interface shown in FIG. 4E, the member device 102-1 displays selectable objects, such as availability check object 418, location object 420, and information objects 422. In response to a user selection of location object 420, for example, the member device 102-1 transmits a request to the server system 120 to provide a map showing the location of the club. The map may be transmitted by the server system 120 for display on the member device 102-1. Information objects 422, when selected by the user, causes the member device 102-1 to transmit a request to the server system 120 for information about, for example, one or more club amenities/activities (e.g., dining, golfing, fitness, spa), which the server system 120 may transmit for display on member device 102-1 as shown in the user interface of FIG. 4F. The user interface of FIG. 4F may also display availability check object 418.

In response to a user selection of the availability check object 418, the user interface shown in FIG. 4G is displayed on the member device 102-1 which permits the user to prepare a request to check the availability of an amenity or activity of the club. The user interface of FIG. 4G displays one or more fields which allows the user to input or select information relating to the request. For example, the user interface of FIG. 4G may include an activity field 424 which allows the user to input or select information relating to the type of amenity/activity, a number of people field 426 which allows the user to input or select the number of proposed participants, and a date and time field 428 which allows the user to input or select the desired date and time of the proposed amenity/activity. The user interface of FIG. 4G also includes a check object 430, which the user may select to generate the request after fields 424, 426, and 428 have been filled by the user. FIG. 4H shows an example user interface wherein fields 424, 426, and 428 have been filled by the user. In this example, the user has selected “Main Dining Room” in activity field 424, “4” as the number of proposed participants in number field 426, and “May 20” and “06:00 PM” as the desired date and time in date and time field 428. Once fields 424, 426, and 428 have been inputted, the user selects check object 430 to generate a request to check for the availability at the club of the amenity/activity entered into activity field 424 for the number of people entered into number field 426 and at the date/time entered into date and time field 428.

The generated request may be in the form of a request message 432 (e.g., an Email message) which is shown on a preview interface displayed on the member device 102-1 as shown in FIG. 41. The request message 432 may be automatically populated with, for example, the intended recipient information (e.g., club contact), the information inputted by the user in fields 424, 426, and 428, and the user's contact information. After reviewing the user message 432, the user may select send object 434 which causes the member device 102-1 to transmit the message to server system 120. Server system 120 in turn sends a message to a club contact (e.g., club concierge) which includes the request message 432 as well as a request for the club contact (also referred to herein as “club administrator”) to respond to the request message 432. Providing a common interface to enable authorized members to generate requests (and corresponding request messages 432) to access any particular resource/amenity of many different restricted resources at any particular membership organization of a number of unrelated membership organizations promotes efficient use of such restricted resources by members, promotes efficient use of network and computing resources, and promotes efficient use of member club staff resources due to all necessary request information being contained in a single request message and presented in a common format for all participating membership organizations (which in turn promotes automated handling of at least some requests by request processing software that can be used by any of the member organizations and implemented at either or both the server system 120 or administrator devices 102-2).

FIG. 4J shows an example message sent from server system 120 to the club contact which may be displayed on administrator device 102-2 used by a club administrator at IronWood Country Club. The message may include the request message 432 and a response object 436. In response to the club contact's selection of the response object 436, the administrator device 102-2 transmits a request, to the server system 120, to provide a response interface for responding to the user message 432. The server system 120, in response to the request, transmits the response interface shown in FIG. 4K to the administrator device 102-2. The user interface of FIG. 4K includes several selectable response objects, such as an accept object 438, an alternatives object 440, a contact object 442, and an unavailable object 444. Each of these selectable response objects may be selected by a club administrator at IronWood Country Club to respond to a request from the member.

FIG. 4L illustrates an example user interface displayed on the administrator device 102-2 after an administrator selects the accept object 438 on the user interface shown in FIG. 4K. The user interface may include a message 446 that indicates that a response indicating acceptance of the reservation request will be transmitted to the member device 102-1. The user interface may also include cost input functionality 448 that allows an administrator to enter cost information for the member to use the amenity. In this example, the cost information includes a cost for certain items, or that the member will have to pay the cost as specified on the menu pricing. A selectable response object 450 may be displayed, such that, when the response object 450 is selected by the administrator, the administrator device 102-2 transmits a response to the server system 120 for further transmission to the member device 102-1.

FIG. 4M shows an example response message sent from server system 120 to the club member which may be displayed on member device 102-1, subsequent to FIG. 4L in accordance with some implementations. The message may include the response message 446 confirming that the main dining room may be reserved. In some implementations, the member must additionally respond to the server system 120 to confirm the reservation using selectable objects, such as “book it” object 452 or “cancel” object 454. In response to the club contact's selection of the “book it” object 452, the member device 102-1 transmits a confirmation, to the server system 120, to confirm the reservation. In response to the club contact's selection of the “cancel” object 454, the member device 102-1 transmits a cancellation request, to the server system 120, to cancel the reservation.

FIG. 4N illustrates an example user interface displayed on the administrator device 102-2 after an administrator selects the alternatives object 440 on the user interface shown in FIG. 4K. The user interface may also include one or more alternative reservation input functionality sections (e.g., sections 456 and 458) that allows an administrator to suggest alternative locations, party size, dates, times and/or costs for the reservation. A selectable response object 460 may be displays, such that, when the response object 460 is selected by the administrator, the administrator device 102-2 transmits a response to the server system 120 for further transmission to the member device 102-1.

FIG. 4O shows an example response sent from server system 120 to the club member which may be displayed on member device 102-1, subsequent to FIG. 4N in accordance with some implementations. The response may include a user message 459 indicating that the main dining room cannot be reserved. In some implementations, the response may also include the alternative reservations 462 created by the administrator on the user interface in FIG. 4N. In these implementations, a member must additionally respond to the server system 120 to confirm the reservation using one of the selectable objects (e.g., 463-1, 463-2, 463-3) in the alternative reservations 462. In response to the club contact's selection of the “book it” object 452, the member device 102-1 transmits a confirmation, to the server system 120, to confirm the reservation for the specific alternative reservation. In response to the club contact's selection of the “cancel” object 464, the member device 102-1 transmits a cancellation request, to the server system 120, to cancel the reservation.

FIG. 4P illustrates an example user interface displayed on the administrator device 102-2 after an administrator selects the contact object 442 on the user interface shown in FIG. 4K. The user interface may include a message 466 intended to be sent to a member indicating a request for the member to contact the administrator. The message may include a user selectable object 468 that, when selected, causes a member device 102-1 to transmit a contact request to the administrator device 102-2. A selectable response object 470 may be displayed, such that, when the response object 470 is selected by the administrator, the administrator device 102-2 transmits a response to the server system 120 for further transmission of the response to the member device 102-1.

FIG. 4Q shows an example response sent from server system 120 to the club member which may be displayed on member device 102-1, subsequent to FIG. 4P in accordance with some implementations. The response may include the message 466 indicating a request for the member to contact the administrator. The response may also include user selectable object 468 that, when selected, causes a member device 102-1 to transmit a contact request to the administrator device 102-2. In some implementations, a member must additionally respond to the server system 120 via user selectable object 468 to confirm the reservation. In response to the member's selection of the user selectable object 468, the member device 102-1 transmits a request, to the server system 120, to contact the administrator. In response to a member's selection of the “cancel” object 472, the member device 102-1 transmits a cancellation request, to the server system 120, to cancel the reservation request.

FIG. 4R illustrates an example user interface displayed on the administrator device 102-2 after an administrator selects the unavailable object 444 on the user interface shown in FIG. 4K. The user interface may include a message 474 intended to be sent to a member indicating cancellation of the member's reservation request.

FIG. 4S shows an example response sent from server system 120 to the club member which may be displayed on member device 102-1, subsequent to FIG. 4R in accordance with some implementations. The response may include the message 474 indicating cancellation of the member's reservation request.

FIGS. 4T and 4U show an example authentication procedure, according to some implementations. When a user checks in at a host club to use the facilities as a non-member, the user is authenticated (e.g., the user is checked to be the person who has been granted to a limited resource at that club). FIG. 4T shows an example Email sent from server system 120 to a host club contact 476 which may be displayed on administrator device 102-2 used by a host club administrator (at R Club, in this example), according to some implementations. The Email in this example includes information 478 about the user including a picture or Photo ID 480 of the user. In some implementations, the Email includes selectable objects for the host club administrator to seek further information from the server system 120 for further authentication. Similar user information (482, FIG. 4U) and a copy of the Photo ID 484 is sent to the user (sometimes herein called a participating member, a guest user, or a guest member) and/or the home club (e.g., the club where the user is a member) as a way of confirmation. When the guest user visits the host club, the guest user is authenticated by the host club using the pictures (any other authenticating information returned by the server system 120) in the one or more Emails.

When a guest member uses a facility, the host club may submit an invoice for payment. In some implementations, a host club charges a guest member directly (e.g., via credit card payments). In some other implementations, a host club charges a home club of the guest member using the communications from the server system 120.

In some implementations, when a guest member checks in or books a facility at a host club, the server system 120 sends an Email to the home club indicating that the guest member has booked in at the host club.

FIG. 5 is a flow diagram illustrating a method 500 allocating access to one or more restricted resources in accordance with some implementations. The method 500 is performed at one or more computing devices (e.g., first client device 102-2 and server system 120). Some operations in method 500 are, optionally, combined and/or the order of some operations is, optionally, changed.

As described below, the method 500 provides an intuitive way to selectively provide access to a restricted resource. The method reduces the number, extent, and/or nature of the inputs from a user when attempting to access a restricted resource or considering whether to grant access to a restricted resource, thereby creating a more efficient human-machine interface with less human-initiated inputs that reduces overhead and provides a better overall user experience.

The first client device (e.g., client device 102-1) launches (502) an application configured to enable the requesting user to request access to restricted resources at a plurality of entities, the requesting user being associated with a first entity of the plurality of entities. For example, in FIG. 4A, in response to a user input at application icon 401, the client device 102-1 launches the club network application.

In response to the launching, the first client device transmits (504) a first request to a server (e.g., server system 120) to allow the requesting user of the client device to initiate a request to access one or more of the restricted resources.

In response to receiving the first request, the server (e.g., server system 120) determines (506) whether the requesting user and/or the client device meets access criteria. In accordance with a determination that the requesting user and/or client device meets access criteria, the server transmits (508) a list of available entities to the client devices. In some implementations, access criteria include a criterion that is met when the user and/or client device has access to other restricted resources at the first entity. For example, the server system 120 determines whether a requesting user can access the club network application by conducting a database lookup of the membership status of the requesting user at his/her home country club (e.g., Oakmont Country Club). If the server system 120 determines that the requesting user has a suspended membership status, the server system 120 denies the requesting user access to the club network application, as shown in FIG. 4B. If the server system 120 determines that the requesting user has an active membership status, the server system 120 allows the requesting user to access the club network application and transmits a list of available entities to the client device 102-1, as shown in FIG. 4C.

The server receives (510) a second request from the user to access restricted resources at a second entity of the plurality of entities at a first range of dates specified by the user, the second entity being separate and distinct from the first entity. For example, as shown in FIG. 4D, the requesting user may be a member of Oakmont Country Club (i.e., a first entity) while requesting access to amenities (i.e., restricted resources) at Ironwood Country Club (i.e., the second entity) via selection of object 416. In some implementations, the requesting user may specify a data range when the user may be in the vicinity of Ironwood Country Club.

In response to the second request, the server (512) generates a list of restricted resources that satisfy predefined blackout criteria specified by the second entity for the first range of dates and transmitting the list of restricted resources to the client device for displaying in the application. For example, as shown in FIG. 4G, a list of available amenities (i.e., restricted resources) generated by, and transmitted from, the server system 120 is available for selection by a user. In some implementations, the list of available amenities that may have availability that falls within a date range, such as when the requesting user may be in the vicinity of Ironwood Country Club, or falls within a date range selected by a member (e.g., a date and/or time).

The server receives (514) a third request from the user for access to a first restricted resource of the list of restricted resources at the second entity, the third request including a first time specified by the requesting user. For example, as shown in FIG. 4H, the server system 120 receives a request to make a reservation for the main dining room at the Ironwood Country Club at 6:00 pm on May 20th.

In response to receiving the third request for the restricted resource; the server transmits (516) the third request to a second client device of a super user associated with the second entity. For example, as shown in FIG. 4K, the second client device 102-2 displays a user interface that includes the request from the requesting user (via the server system 120) to make a reservation for the main dining room at the Ironwood Country Club.

The server receives (518) a first response to the request from the super user via the second client device (e.g., client device 102-2) and the server transmits (520) the first response to the first client device. In some implementations, the first response to the request from the super user indicates that the requesting user has permission to access the first restricted resource at the first time specified by the user. For example, as shown in FIG. 4M, the first client device 102-1 can display a user interface of a response message that includes an indication the request from the requesting user to make a reservation for the main dining room at the Ironwood Country Club was accepted. In some implementations, the first response to the request from the super user (i) indicates that the requesting user does not have permission to access the first restricted resource at the first time specified by the user and (i) indicates proposed alternative times for the requesting user to access the first restricted resource. For example, as shown in FIG. 4O, the first client device 102-1 can display a user interface of a response message that includes an indication the request from the requesting user to make a reservation for the main dining room at the Ironwood Country Club was rejected, but alternative reservation times are proposed. In some implementations, the first response from the super user includes a request for the requesting user to contact the user. For example, as shown in FIG. 4Q, the first client device 102-1 can display a user interface of a response message that indicates that the club administrator would like the requesting user to contact him/her. In some implementations, the first response to the request from the super user indicates that the requesting user has been denied permission to access the first restricted resource. For example, as shown in FIG. 4S, the first client device 102-1 can display a user interface of a response message that indicates that the club administrator denied the reservation request from the requesting user.

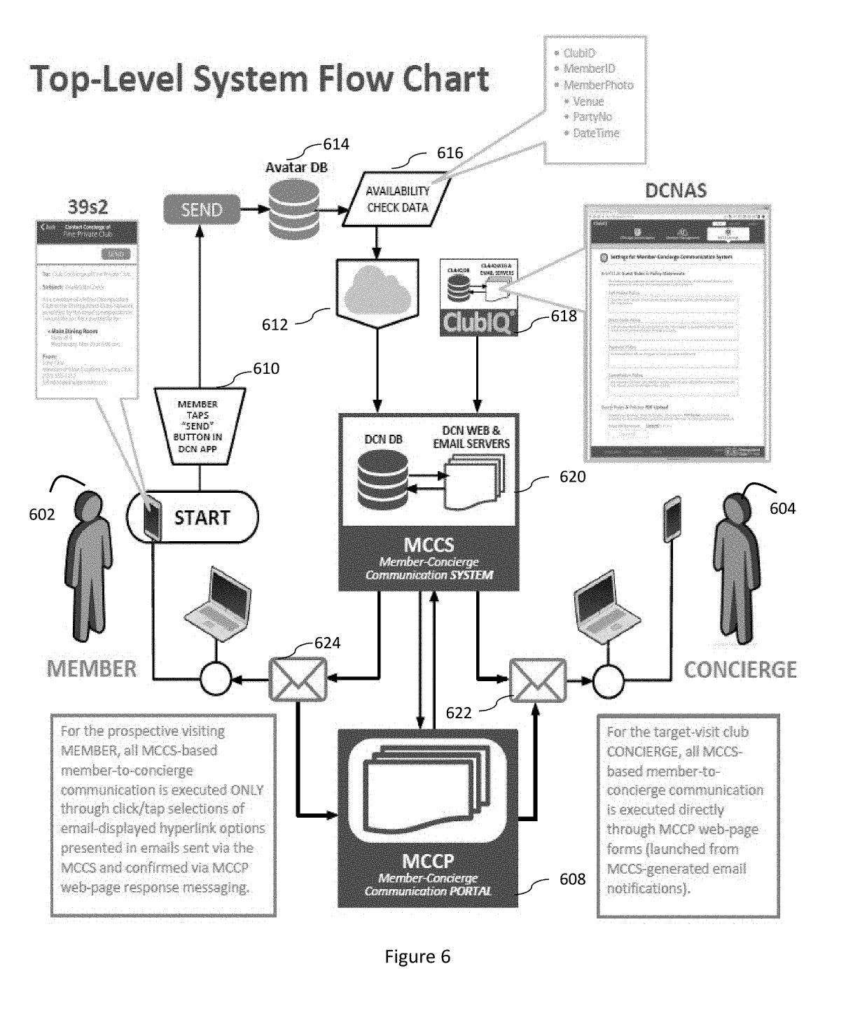

FIG. 6 is a top-level flow chart of an example system (e.g., server system 120) that provides selective access to restricted resources, according to some implementations. A member user 602 interacts with the system via an application, and initiates the operations by requesting to use a facility (e.g., at a host club). For example, the member taps 610 a send button in an application running on a mobile client. This action causes the client application to send a request to a database 614 (part of server system 120) and the availability of the facility is checked 616. In various implementations, a club ID, a member ID, a member photo, venue, date or time information is used for checking availability information. A Member-Concierge Communication System (MCCS) module 620 receives the resource availability from a network 612, and additionally uses information regarding the various clubs (ClubIQ 618), to generate communications to the member 602 and a concierge 604. In various implementations, the MCCS consists of a database server (DCN DB) and/or a web and Email servers (shown as DCN Web and Email servers). For the prospective visiting member 602, the MCCS-based member-to-concierge communication is executed through click/tap selections of Emails 624 sent via the MCCS and confirmed via a Member-Concierge Communication Portal (MCCP) module 608 web-page response messaging. For the target-visit club concierge 604, all MCCS-based member-to-concierge communication is executed directly through MCCP web-page forms (launched from MCCS-generated Email notifications 622).

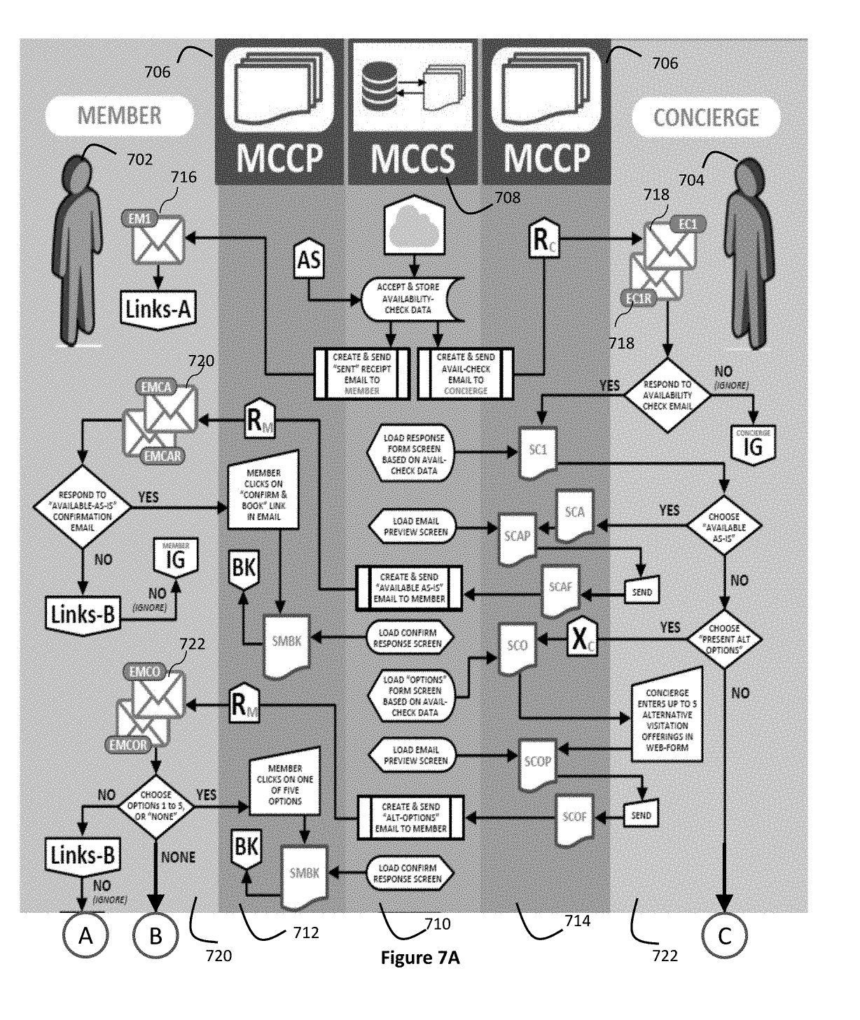

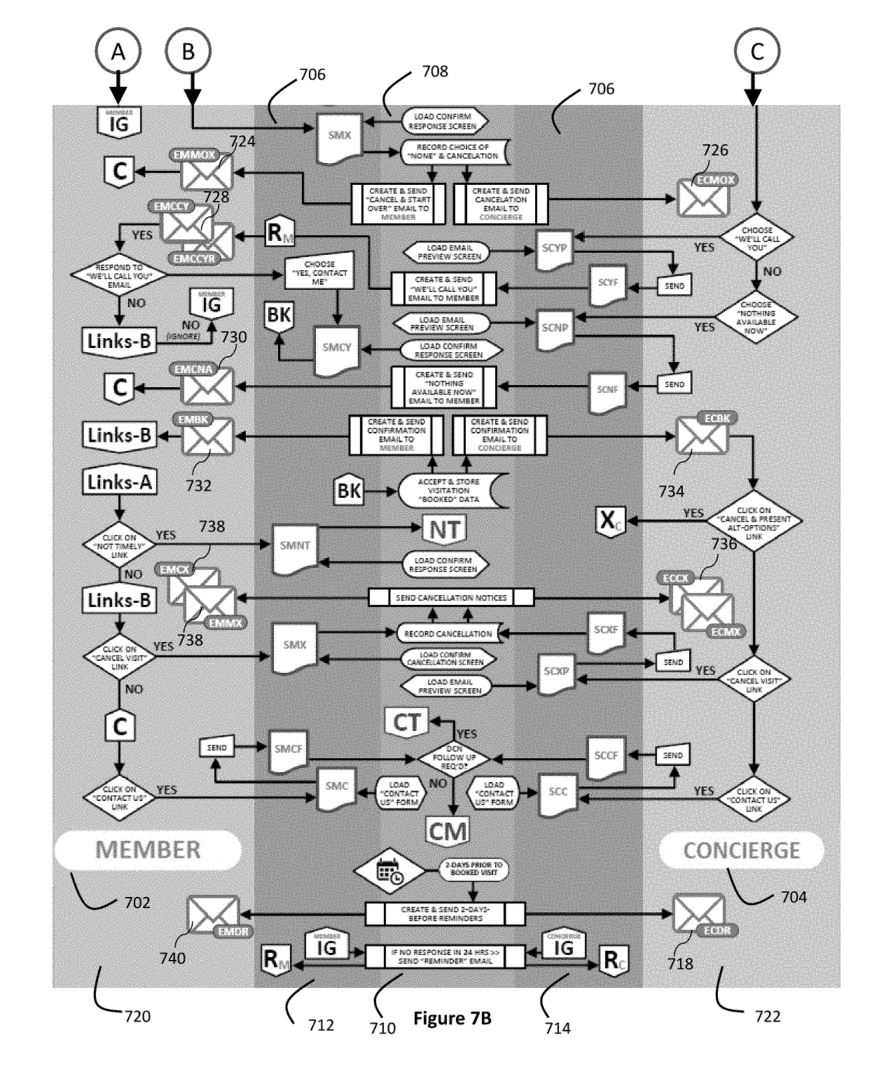

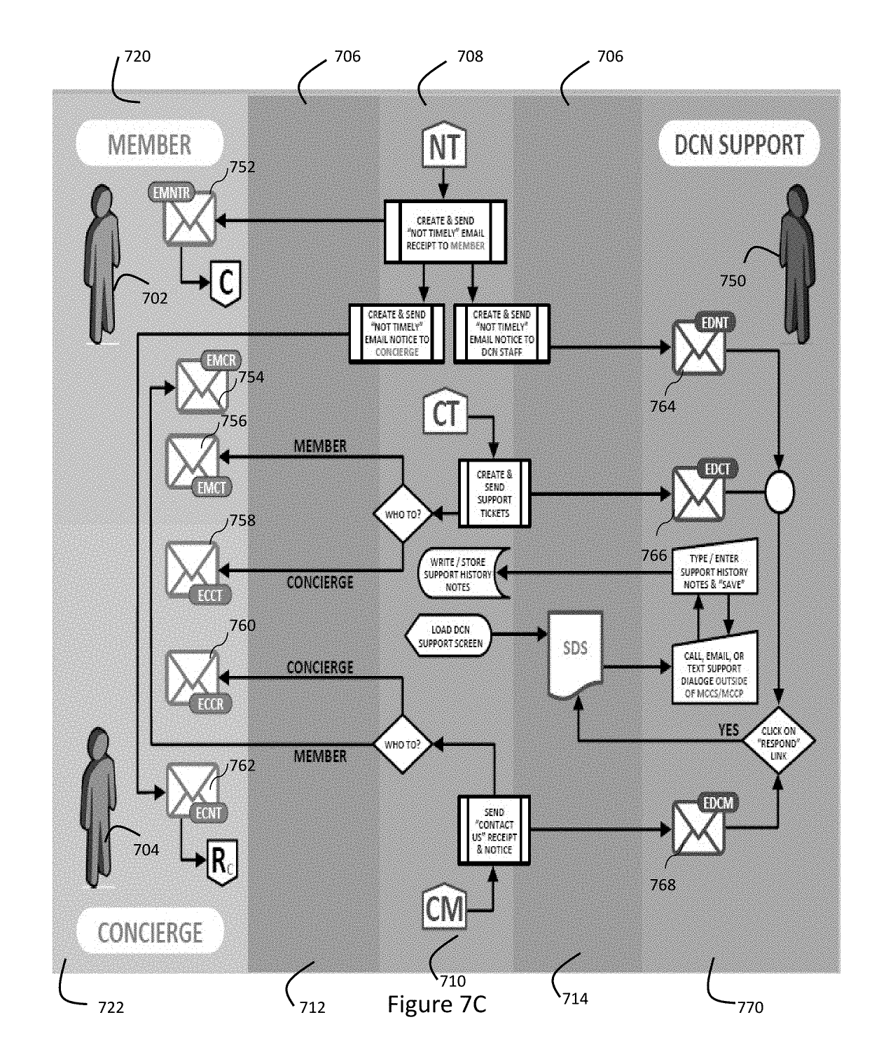

FIGS. 7A, 7B, and 7C illustrate steps performed in a system (e.g., server system 120) that provides selective access to restricted resources, according to some implementations. FIGS. 7A, 7B, and 7C illustrate example steps of various modules of the system (e.g., MCCS and MCCP in FIG. 6) in greater detail. As in FIG. 6, a member 702 initiates a request (not shown in FIG. 7A) to the system. The operations shown in FIGS. 7A and 7B are better understood top-down (i.e., operations at the top happen before the ones in the bottom). In some implementations, rather than executing every step of the flowchart, one or more modules execute only a subset of operations. Moreover, because some operations are triggered by external responses (e.g., a user selecting an object sent via an Email sent a week ago), the system is always on, adapting to changing circumstances, responding spontaneously, according to various implementations.

The operations of the Member-Concierge Communication System (MCCS) module 708 are shown in the band 710 in the middle in FIGS. 7A and 7B, according to some implementations. The operations of the Member-Concierge Communication Portal (MCCP) module 706 are shown in the two bands on either side of the purple band 710—the band to the left (712) shows operations that interface with member 702, and the band to the right (714) shows operations that interface with the concierge 704, according to some implementations. Some operations span the two modules MCCS and MCCP and shown on bands 710 and 712, and 714 and 710, according to some implementations. The labels A, B, and C in FIG. 7A are continued in FIG. 7B. As shown, the system interfaces with the member user 702 via one or more Emails (with live links to selectable objects) 716, according to some implementations. Similarly, the system interfaces with the concierge 704 via one or more Emails 718, according to some implementations. The operations in the band 720 on the left show the operations by the member 702, according to some implementations. As shown, the member 702 responds to Email requests 716 from the MCCS and/or MCCP (sometimes herein called the server, e.g., server system 120) by clicking on selectable objects in the respective Emails and provides feedback to the server system, according to some implementations. Similarly, the concierge 704 responds to Email requests 718 from the MCCS and/or MCCP by clicking on selectable objects in the respective Emails and provides feedback to the server system, according to some implementations. It is contemplated that, in some implementations, user interface files (e.g., web pages) may be used instead of emails.

Attention is now directed to the band 710 and the two bands 712 and 714 that indicate the operations of the MCCS 708 and the MCCP 706 modules. In some implementations, the MCCS module 708 receives a request from a network (indicated by the cloud), and in response, receives stored data from an accept and store (AS) to check availability data. The MCCS module 708 then creates and sends a sent receipt Email 716 to member 702, and creates and sends an availability check Email 718 to concierge 704.

In some implementations, when a response to availability check Email 718 is received from the concierge 704, the MCCS module 708 loads response form screen based on availability check data and passes the form to the MCCP module 706. In some implementations, upon receipt of a response from the concierge (e.g., via the MCCS) that the concierge has chosen an as-is availability option, the MCCS module loads an Email preview screen that is shown on an application or client on the concierge's device. When the concierge 704 chooses to send the previewed Email, the MCCS module receives (e.g., via MPCCP module 706) the request and creates and sends an “available as-is” Email 720 to the member 702. The member 702 responds to the “available as-is” confirmation Email by clicking a selectable object which is registered by the MCCP module 706. The MCCS module 708 loads a confirm response screen and sends the screen to the member 702 (e.g., via the MCCP module 706). If the concierge 704 chooses a “present alt options” that indicates a choice different from the “available as-is” option, the MCCS module 708 loads “options” form screen based on avail-check data and sends the form to the concierge 704 (e.g., via the MCCP module 706). The concierge 704 enters (makes a selection) of up to a predefined number of alternative visitation offerings (e.g., 5 offerings) in web-form, in response to which, the MCCS module 708 loads an Email preview screen and posts it to the concierge 704 (e.g., via the MCCP module 706). The concierge 704 chooses to send the “alt-options” which is received by the MCCS module 708 which responds by creating and sending an “alt-options” Email 722 to the member 702. The member 702 selects one or more of the “alt-options” (e.g., options 1 to 5, shown by the path YES in the bottom-left of FIG. 7A), chooses none of the “alt-options” (shown as path B), chooses not to respond at all (path A). In some implementations, the member 702 selects by clicking on one of the alt-options, in response to which the MCCS module 708 responds by loading confirm response screen which is displayed to the member 702 (e.g., via the MCCP module 706). The flowchart is continued in FIG. 7B described next.

If the member 702 selects none of the options (path B), the MCCS module 706 loads a confirmation response screen communicated to the member 702 (e.g., via the MCCP module 706), and the MCCS module then records choice of “none” and cancellation by creating and sending a cancel and start over Email 724 to member 702, and by creating and sending cancellation Email 726 to the concierge 704, according to some implementations.

In some implementations, if the concierge 704 does not choose “present alt options,” but instead chooses a “we'll call you” option, this selection is communicated to the MCCS module 708 (e.g., via the MCCP module 706) which loads an Email preview screen for the concierge 704. The concierge 704 then chooses to send this Email to the member 702 which is received by the MCCS module 708 (e.g., via the MCCP module 706) in response to which the MCC module 708 creates and sends a “we'll call you” Email 728 to the member 702. If the member 702 responds to the “we'll call you” Email 726, the MCCP module registers that the member 702 has chosen for the concierge 704 to be contacted later (e.g., labelled “Yes, contact me”) by accessing AS store to accept and store visitation of “booked” data, creating and sending a confirmation Email 732 to member 702, and creating and sending confirmation Email 734 to concierge 704.

In some implementations, when the concierge 704 clicks on “cancel and present alt-options” link in the confirmation Email 734, the MCCS module 708 proceeds as described above in relation to “present alt options.” If, on the other hand, the concierge 704 clicks on the “cancel visit” link in the Email 734, the MCCS module 708 receives the request (e.g., via the MCCP module 706) and loads an Email preview screen for the concierge 704 who chooses to send the previewed Email. In response, the MCCS module 708 records the cancellation, and sends cancellation notices (Email 736 to the concierge 704, and Email 738 to the member 702).

In some implementations, if the concierge 704 does not choose the “we'll call you” later option, but instead chooses “nothing available now,” this choice is communicated to the MCCS module 708 (e.g., via the MCCP module 706) and the MCCS module 708 loads an Email preview screen which is posted to the concierge 704 (e.g., via the MCCP module 706) who chooses to send the Email 716 to the member 702. The MCCS module receives the request from the concierge 704 (e.g., via the MCCP module 706) and creates and sends a “nothing available now” Email 730 to the member 702.

In some implementations, if the member 702 clicks on “not timely link” in the Email 716, the MCCS module 708 receives the response and loads a confirm response screen, and if the member 702 confirms (not shown), then the MCCS module 708 creates and sends a “not timely” Email 752 receipt to the member 702, a “not timely” Email notice 762 to the concierge 704, and a “not timely notice” Email 764 to a support staff 750 (labelled DCN Support), as shown in FIG. 7C. If the support staff 750 clicks on the “respond” link in the Email 764, the MCCS modle is notified (e.g., via the MCCP module 706) and loads a support screen displayer to the support staff 750 who either calls, Emails or texts support dialogue. In some implementations, the support related information is typed or entered into a support history notes and saved by the support staff which is notified to the MCCS module (e.g., via the MCCP module 706) which writes/stores support history notes into a database.

In some implementations, if the member or 702 or the concierge 704 click on a “contact us” link in any of the Emails shown in FIG. 7A or 7B, and if follow-up is required (as indicated by either the member 702 or the concierge 704 from whom the “contact us” request is received), the MCCS module 708 is notified (e.g., via the MCCP module 706) which then creates and sends support tickets by creating and sending an Email 766 to the support staff 750. If the support staff 750 clicks on the “respond” link in the Email 766, the click is handled as described above. If the member 702 was the one who clicked on the “contact us” link in an Email, the MCCS module 708 creates and sends a response Email 756 to the member 702. If, on the other hand, the concierge 704 was the one who clicked on the “contact us” link in an Email, the MCCS module 708 creates and sends a response Email 758 to the concierge 704.

In some implementations, if the member or 702 or the concierge 704 click on a “contact us” link in any of the Emails shown in FIG. 7A or 7B, and if follow-up is not required (as indicated by either the member 702 or the concierge 704 from whom the “contact us” request is received), the MCCS module 708 is notified (e.g., via the MCCP module 706) which then sends “contact us receipt and notice by creating and sending an Email 768 to the support staff 750. If the support staff 750 clicks on the “respond” link in the Email 768, the click is handled as described above. The MCCS module 708 also sends an Email 760 to the concierge 704 if the concierge was the one who initiated the “contact us” request (in FIG. 7B). Otherwise, the MCCS module 708 sends an Email 754 to the member 702.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles of the disclosure and its practical applications, to thereby enable others skilled in the art to best utilize the various implementations with various modifications as are suited to the particular use contemplated.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Throughout the preceding description, various implementations are described within the context of smart phone cameras, tablets and the like. This is purely for convenience of explanation and is not intended to limit the claims that follow.

What is claimed is:

1. A method for allocating access to one or more restricted resources, the method comprising:
at a client device of a requesting user:
launching an application configured to enable the requesting user to request access to restricted resources at a plurality of entities, the requesting user being associated with a first entity of the plurality of entities;
in response to the launching, transmitting a first request to a server to allow the requesting user of the client device to initiate a request to access one or more of the restricted resources;
at the server:
in response to receiving the first request, determining whether the requesting user and/or the client device meets access criteria;
in accordance with a determination that the requesting user and/or client device meets access criteria, transmitting a list of available entities to the client device;
receiving a second request from the user to access restricted resources at a second entity of the plurality of entities at a first range of dates specified by the user, the second entity being separate and distinct from the first entity;
in response to the second request, generating a list of restricted resources that satisfy predefined blackout criteria specified by the second entity for the first range of dates and transmitting the list of restricted resources to the client device for displaying in the application;
receiving a third request from the user for access to a first restricted resource of the list of restricted resources at the second entity, the third request including a first time specified by the requesting user;
in response to receiving the third request for the restricted resource; transmitting the third request to a second client device of a super user associated with the second entity;
receiving a first response to the request from the super user via the second client device; and
transmitting the first response to the first client device.

2. The method of claim 1, wherein access criteria includes a criterion that is met when the user and/or client device has access to other restricted resources at the first entity.

3. The method of claim 1, wherein the first response to the request from the super user indicates that the requesting user has permission to access the first restricted resource at the first time specified by the user.

4. The method of claim 1, wherein the first response to the request from the super user (i) indicates that the requesting user does not have permission to access the first restricted resource at the first time specified by the user and (i) indicates proposed alternative times for the requesting user to access the first restricted resource.

5. The method of claim 1, wherein the first response from the super user includes a request for the requesting user to contact the user.

6. The method of claim 1, wherein the first response to the request from the super user indicates that the requesting user has been denied permission to access the first restricted resource.

7. The method of claim 1, further comprising:
at the server:
storing the first request, the second request, the third request and the first response in a database.

8. A system for allocating access to one or more restricted resources, the system comprising the first client device, and the server as specified in the preceding claims, the first client device, and the server configured to perform the functions specified in the preceding claims.
